(19) United States
(12) Patent Application Publication
(10) Pub. No.: US 2003/0115710 A1
(43) Pub. Date: Jun. 26, 2003

(54) Apparatus for cleaning bottles

(76) Inventor: Young Cheol Choi, Kwanak-Gu (KR)

Correspondence Address: JORDAN AND HAMBURG LLP, 122 EAST 42ND STREET, SUITE 4000, NEW YORK, NY, 10168, US

(21) Appl. No.: 10/314,550

(22) Filed: Dec. 9, 2002

(30) Foreign Application Priority Data
Dec. 15, 2001 (KR) 2001-79647

(51) Int. Cl. B08B 9/28; B08B 9/20

(52) U.S. Cl. 15/309.2; 15/306.1

(57) ABSTRACT

Disclosed is an apparatus for cleaning bottles made of synthetic resin so as to remove dust or impurities attached to the insides of the bottles by static electricity, in which air in an ionized state is changed into air in a neutral state and the neutr(lized air is injected into the bottles. Conventionally, a mechanism for cleaning the insides of bottles using compressed air has been mainly used. However, in this conventional system, since the compressed air in an ionized state such as cation and anion is supplied into the bottles, dust or impurities attached to the insides of bottles by static elasticity generated therein is electrically charged. Therefore, it is difficult to remove the electrically charged dust or impurities from the insides of bottles. Even though the dust or impurities are eliminated from the bottles by force, the eliminated dust or impurities blow away from the bottles and then are again blown into the bottles by an air flow or pressure difference generated by the flow of the compressed air injected into the bottles, thereby contaminating the bottles and degrading a cleaning effect of the apparatus. In the apparatus for cleaning bottles, air going through filtration and neutralization steps is supplied to clean the insides of bottles, impurities eliminated from the bottles after a cleaning step are separately collected to a collector so as to prevent them from being blown into the bottles, and the positions of the bottles are successively changed several times so as to effectively clean the bottles.

### BACKGROUND OF THE INVENTION

1. Field of the Invention

The present invention relates to an apparatus for cleaning bottles, and more particularly to an apparatus for cleaning bottles made of synthetic resin so as to remove dust or impurities attached to the insides of the bottles by static electricity, in which air in an ionized state is changed into air in a neutral state and the neutralized air is injected into the bottles, thereby preventing the generation of static electricity during the removal of the impurities from the bottles and effectively cleaning the bottles.

2. Description of the Related Art

Generally, various shaped bottles made of synthetic resin used to contain yogurt or other drinks must be cleaned before they are filled with the contents.

Conventionally, a mechanism for cleaning the insides of bottles using compressed air has been mainly used. However, in this conventional system, since the compressed air in an ionized state such as cation and anion is supplied into the bottles, dust or impurities attached to the insides of bottles by static elasticity generated therein is electrically charged. Therefore, it is difficult to remove the electrically charged dust or impurities from the insides of bottles.

Even though the dust or impurities are eliminated from the bottles by force, the eliminated dust or impurities blow away from the bottles and then are again blown into the bottles by an air flow or pressure difference generated by the flow of the compressed air injected into the bottles, thereby contaminating the bottles and degrading a cleaning effect of the apparatus.

Further, in a conventional method for transferring vacant bottles so as to clean them, the bottles are transferred and overturned along a guide rail. However, in this case, the overall length of the guide rail is elongated, thereby increasing the dimension of the apparatus, requiring a large installation space and being noneconomical.

### SUMMARY OF THE INVENTION

Therefore, the present invention has been made in view of the above problems, and it is an object of the present invention to provide an apparatus for cleaning bottles, in which air going through filtration and neutralization steps is supplied to clean the insides of bottles, impurities eliminated from the bottles after a cleaning step are separately collected to a collector so as to prevent them from being blown into the bottles, and a disinfection step is achieved simultaneously during the cleaning step.

It is another object of the present invention to provide an apparatus for cleaning bottles, in which the positions of transferred bottles are successively changed several times and each changed position of the bottles, such as the overturned positions and the upright position, is firmly maintained during corresponding stages of pre-cleaning, cleaning and post-cleaning so as to firmly maintain the overturned state of the bottles during the cleaning and achieve the cleaning process in a short distance of a line, thereby reducing its installation space and being effectively used to clean the bottles.

In accordance with the present invention, the above and other objects can be accomplished by the provision of an apparatus for cleaning bottles so as to eliminate dust or impurities attached to the insides of bottles made of synthetic resin by static electricity by blowing air, comprising means for transferring the bottles to pre-cleaning, cleaning and post-cleaning sections and means for cleaning the insides of the bottles, wherein the transferring means includes: a loading unit for loading the bottles; a transferring unit for successively overturning the bottles loaded by the loading unit to their overturned positions prior to the cleaning so that the insides of the bottles are easily cleaned, maintaining the overturned positions of the bottles during the cleaning, and again overturning the ov□rturned bottles so as to return to their normally upright positions after the cleaning; and an unloading unit for unloading the cleaned bottles to the outside, and wherein the cleaning means includes: an air supplying unit for supplying air to the apparatus by a compressor, filtering the supplied air by a filter and neutralizing the air in an ionized state by an ionizer; an air cleaning unit for injecting the supplied air from the air supplying unit to the insides of the bottles through spraying nozzles so as to eliminate the impurities from the bottles; and an air exhausting unit 36 for transmitting the eliminated impurities from the insides of the bottles to a collector by a suction pump and exhausting the air after the cleaning to the outside.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a front view of an apparatus for cleaning bottles in accordance with a preferred embodiment of the present invention;

FIG. 2 is a right side view of FIG. 1;

FIG. 3 is a plan view of FIG. 2;

FIG. 4 is a perspective view of transferring means of the apparatus for cleaning bottles in accordance with the embodiment of FIGS. 1 and 2;

FIG. 5 is a longitudinal-sectional view of FIG. 4;

FIG. 6 is a longitudinal-sectional view of an essential portion of FIG. 5;

FIG. 7 is a longitudinal-sectional view of an essential portion including transferring means and cleaning means; and

FIG. 8 is a schematic view of the cleaning means of FIGS. 1 and 2.

### DESCRIPTION OF THE PREFERRED EMBODIMENTS

Now, preferred embodiments of the present invention will be described in detail with reference to the annexed drawings.

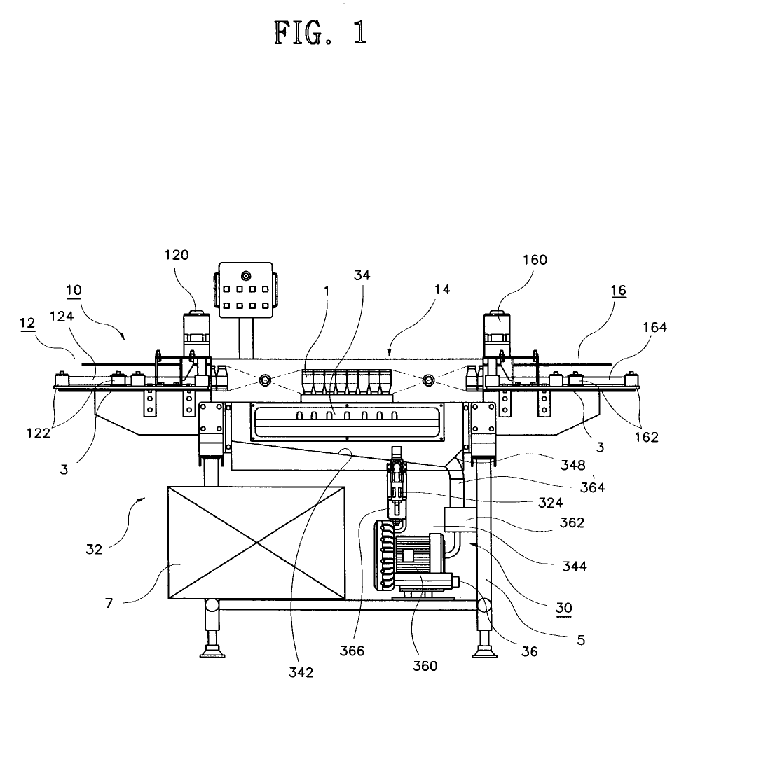

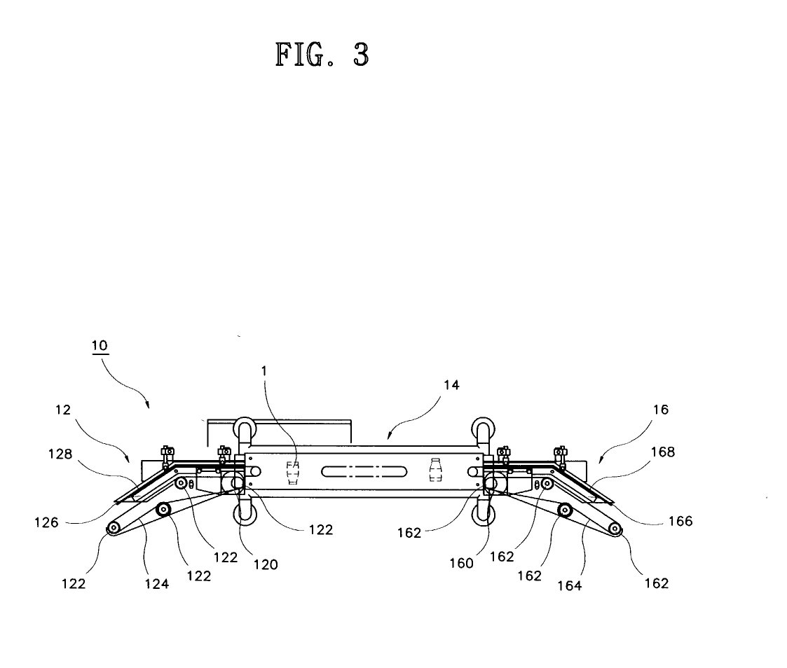

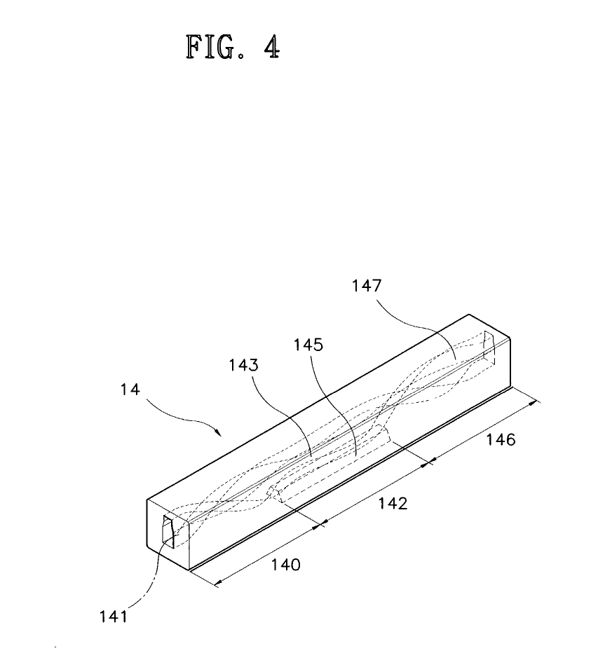

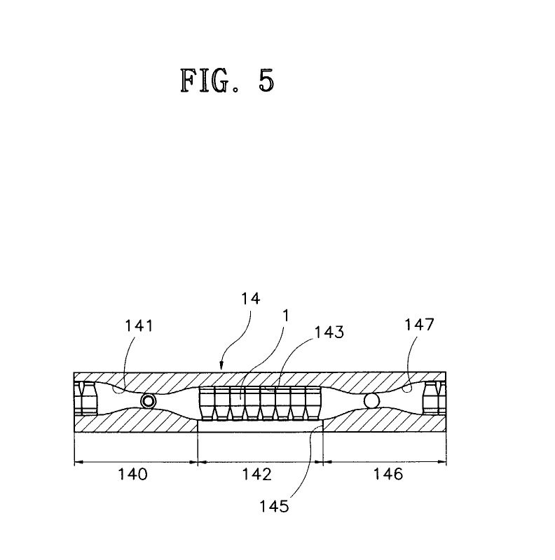

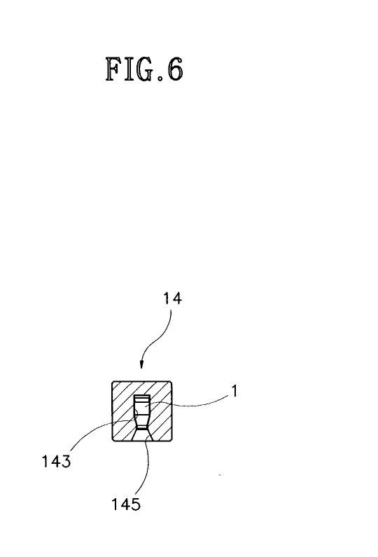

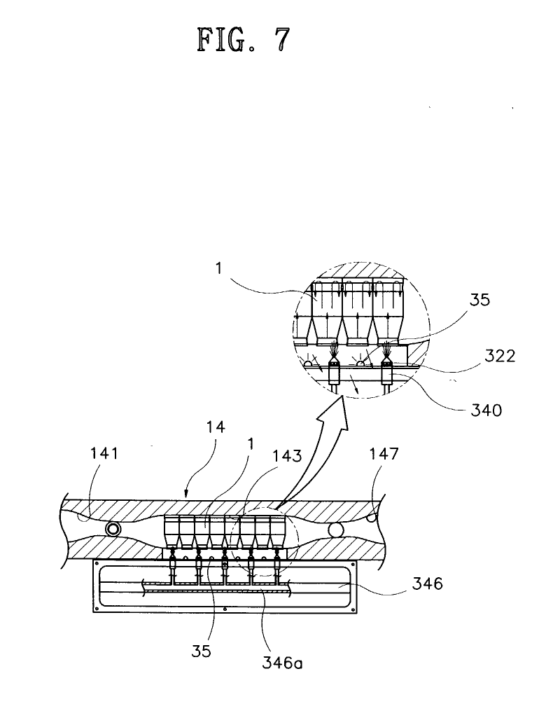

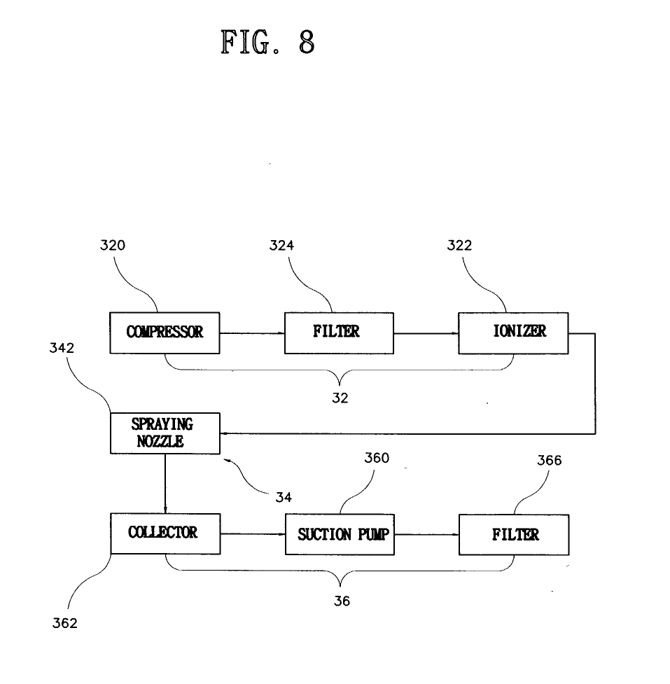

As shown in FIGS. 1 to 8, an apparatus in accordance with the present invention comprises means 10 for transferring bottles 1 to pre-cleaning, cleaning, and post-cleaning sections, and means 30 for cleaning the insides of the bottles 1.

As shown in FIGS. 1 to 3, the transferring means 1 located beyond an engine-waiting track 3 includes a loading unit 12, a transferring unit 14, and an unloading unit 16. The loading unit 12 serves to load the bottles 1. The transferring unit 14 serves to successively overturn the bottles 1 in normally upright positions loaded by the loading unit 12 prior to the cleaning so that the insides of the bottles are easily cleaned, to maintain the overturned positions of the bottles 1 during the cleaning, and to successively overturn again the bottles 1 to normally upright positions after the cleaning. The unloading unit 16 serves to unload the bottles 1 cleaned by the transferring unit 14.

The loading unit 12 includes a transferring belt 124 rotated via several rollers 122 by a motor 120 for controlling the speed of the belt 124 formed on one end of the engine-waiting track 3, and a guider 128 with a cavity 126 separated from the belt 124 by a predetermined distance so as to be opposite to the belt 124, thereby loading the bottles 1 to the transferring unit 14 by the belt 124 when the bottles 1 are located within the cavity 126.

As shown in FIGS. 1 to 6, the transferring unit 14 is located beyond the engine-waiting track 3 between the loading unit 12 and the unloading unit 16, and successively includes a front overturning section 140, a cleaning section 142, and a rear overturning section 146. In the front overturning section 140, the normally upright bottles 1 are successively overturned prior to the cleaning so that the insides of the bottles 1 are easily cleaned. In the cleaning section 142, the overturned positions of the bottles 1 are maintained during the cleaning. In the rear overturning section 146, the overturned bottles 1 are successively overturned again after the cleaning so as to return to their normally upright positions.

Herein, overturning guide spaces 141 and 147 with a curvature portion formed along the trajectory of the bottles 1 generated by a 180° turn are respectively formed within the front and rear overturning sections 140 and 146. A transferring guide space 143 with a curvature portion formed along the trajectory of the bottles generated by a straight-line movement is formed within the cleaning section 142. A through hole 145 for allowing air sprayed from spraying nozzles 340 of the cleaning means 30 to be directly injected into the inside of the bottles 1 is longitudinally formed on the lower surface of the guide space 143.

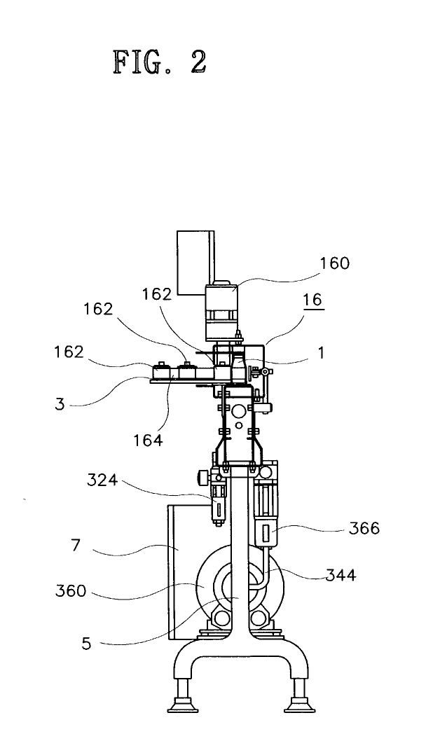

As shown in FIGS. 1 and 2, the unloading unit 16 is formed so as to be symmetrical with the loading unit 12, and includes a transferring belt 164 rotated via several rollers 162 by a motor 160 for controlling the speed of the belt 164 formed on one end of the engine-waiting track 3, and a guider 168 with a cavity 166 separated from the belt 164 by a predetermined distance so as to be opposite to the belt 164, thereby unloading the bottles 1 to the outside of the apparatus for other processes by the belt 164 when the bottles 1 are located within the cavity 166.

The cleaningnmeans 30 located below the transferring means 10 includes an air supplying unit 32, an air cleaning unit 34, and an air exhausting unit 36. In the air supplying unit 32, air is supplied into the air-supplying unit 32 by a compressor 320 and filtered by a filter 324, and the air in an ionized state is changed into air in a neutral state by an ionizer 322. The air cleaning unit 334 injects the supplied air from the air supplying unit 32 to the insides of the bottles 1 through the spraying nozzles 340, thereby serving to eliminating the impurities from the insides of the bottles 1. The air exhausting unit 36 transmits the eliminated impurities from the insides of the bottles 1 to a collector 362 by a suction pump 360 and exhausts the injected air after the cleaning to the outside.

Herein, as shown in FIGS. 1 to 3 and FIGS. 6 to 8, the air supplying unit 32 is formed so that the supplied external air in the ionized state passing through the filter 324 to the compressor 320 is changed to the air in the neutral state by the ionizer 322 and then supplied to a plurality of the spraying nozzles 340 by a compression air supply pipe 344.

In the air cleaning unit 34, the compression air supply pipe 344 and a distributor 346 are connected to each other within a hermetic duct 342 installed under the engine-waiting track 3, a plurality of the spraying nozzles 340 spaced from each other by a designated distance are installed between the distributor 346 and the through hole 145 so as to be connected to the inside 346a of the distributor 346, and a discharge slot 348 is formed on one end of the duct 342.

Herein, the aforementioned ionizer 322 may be installed on the spraying nozzle 340 so as to immediately neutralize the air passing through the spraying nozzle 340. A plurality of bactericidal lamps 35 such as ultraviolet lamps may be respectively installed between the spraying nozzles 340 on the distributor 346, thereby radiating a bactericidal light to the insides of the bottles 1 via the through hole 145 so as to disinfect the insides of the bottles 1.

In the air exhausting unit 36, the discharge slot 348 and the collector 362 are connected to each other by a connection pipe 364 so that the impurities eliminated from the bottles 1 by the air cleaning unit 34 are collected into the collector 362 by the suction pump 360 such as a ring blower and the exhausted air is discharged to the outside via a filter 366. The collector 362 and the suction pump 360 are connected to each other and the suction pump 360 and the filter 366 are connected to each other so that the impurities and air exhausted from the duct 342 by the suction pump 360 are separated from each other within the collector 362, and only the impurities remain within the collector 362 but the air is filtered and discharged to the outside via the suction pump 360 and the filter 366.

Herein, non-described reference numerals 5 and 7 respectively denote supporting legs for supporting the engine-waiting track 3 and a control panel.

Hereinafter, an operation of the aforementioned cleaning apparatus in accordance with -the present invention will be described inddetail.

The apparatus for cleaning bottles of the present invention is installed on a manufacturing line of food and/or drink such as yogurt. First, the bottles 1 required to be cleaned are successively fed to the loading unit 12 of the transferring means 10. In the loading unit 12, the bottles 1 are transferred to the front overturning section 140 of the transferring unit 14 through the cavity 126 formed on the guider 128 along the belt 124 operated by the motor 120.

As the bottles 1 go through the overturning guide space 141 of the front overturning section 140, the bottles 1 in normally upright states are overturned by 180°.

Next, the overturned bottles 1 rectilinearly move along the transferring guide space 143 via the through hole 145 of the cleaning section 142. At this time, the cleaning means 3 is already operated so that the air filtered and neutralized by the compressor 320, the filter 324, and the ionizer 322 is upwardly sprayed from the spraying nozzles 340 of the air cleaning unit 34. Thereby, the neutralized air sprayed from the spraying nozzles 340 is injected to the insides of the transferred bottles 1 via the through hole 145.

Herein, since a plurality of the spraying nozzles 340 are linearly arranged, the air is injected into the inside of the bottle 1 located on the corresponding spraying nozzle 340 and the impurities are eliminated from the insides of the bottles 1. The eliminated impurities go through the through hole 145, and fall downwardly. Particularly, the air injected into the insides of the bottles 1 is not charged but neutralized, thereby preventing the generation of the static electricity within the bottles 1 and easily eliminating the impurities from the insides of the bottles 1. Since the bottles 1 successively pass through a plurality of the spraying nozzles 340 arranged in the transferring direction of the bottles 1, the insides of the bottles 1 are cleaned several times.

The impurities eliminated from the bottles 1 fall into the duct 432 via the through hole 14, and then are collected to the collector 362 via the discharge slot 348 and the connection pipe 364 by the operation of the suction pump 360 in the air exhausting unit 36. The exhausted air passes through the suction pump 360 and is filtrated by the filter 366, and the filtrated air is discharged to the outside of the apparatus. The collector 362 containing the impurities eliminated from the bottles 1 is periodically emptied.

In case the bactericidal lamp 35 is installed on the duct 342 of the air cleaning unit 34, the bactericidal lamp 35 radiates a bactericidal light to the insides of the transferred bottles 1, thereby achieving a bactericidal action within the bottles 1.

After the bottles 1 located on the cleaning section 142 are cleaned by the air cleaning unit 34, the cleaned bottles 1 in overturned positions are again overturned by 180° along the guide space 147 of the rear overturning section 146 so as to return to their normally upright positions, and then exhausted to the outside of the apparatus. Herein, the bottles 1 are exhausted to the outside of the apparatus through the cavity 166 formed on the guider 168 along the belt 164 operated by the motor 160. Then, the exhausted bottles 1 are loaded to a process for filling the bottles 1 with contents.

As apparent from the above description, the present invention provides an apparatus for cleaning bottles 1, in which air going through filtration and neutralization steps is supplied to clean the insides of bottles 1, impurities eliminated from the bottles 1 after a cleaning step are separately collected to a collector so as to prevent them from being blown into the bottles 1, and a disinfection step is achieved simultaneously during the cleaning step.

Further, since the apparatus for cleaning bottles of the present invention successively changes the positions of the transferred bottles several times and firmly maintains each changed position, that is, the overturned position and the normally upright position during corresponding stages of pre-cleaning, cleaning and post-cleaning, the apparatus firmly maintains the overturned positions of the bottles during the cleaning and achieves the cleaning process in a short distance of a line, thereby reducing its installation space and being effectively used to clean the bottles.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for cleaning bottles so as to eliminate dust or impurities attached to the insides of bottles made of synthetic resin by static electricity by blowing air, comprising means for transferring the bottles to pre-cleaning, cleaning and post-cleaning sections and means for cleaning the insides of the bottles,
wherein said transferring means includes:
a loading unit for loading the bottles;
a transferring unit for successively overturning the bottles loaded by the loading unit to overturned positions prior to the cleaning so that the insides of the bottles are easily cleaned, maintaining the overturned positions of the bottles during the cleaning, and again overturning the overturned bottles so as to return to their normally upright positions after the cleaning; and
an unloading unit for unloading the cleaned bottles to the outside, and
wherein said cleaning means includes:
an air supplying unit for supplying air thereto by a compressor, filtering the supplied air by a filter and neutralizing the air in an ionized state by an ionizer;
an air cleaning unit for injecting the supplied air from the air supplying unit to the insides of the bottles through spraying nozzles so as to eliminate the impurities from the bottles; and
an air exhausting unit 36 for transmitting the eliminated impurities from the insides of the bottles to a collector by a suction pump and exhausting the air after the cleaning to the outside.

2. The apparatus for cleaning bottles as set forth in claim 1,
wherein said loading unit includes a transferring belt rotated via several rollers by a motor formed on one end of an engine-waiting track, and a guider with a cavity separated from the belt by a predetermined distance so as to be opposite to the belt,
wherein said transferring unit is located beyond the engine-waiting track between the loading unit and the unloading unit, and successively includes a front overturning section for successively overturning the normally upright bottles prior to the cleaning so that the insides of the bottles are easily cleaned, a cleaning section for maintaining the overturned positions of the bottles and transferring the bottles during the cleaning, and a rear overturning section for successively overturning the overturned bottles again after the cleaning so as to return to their normally upright positions, and
wherein said unloading unit is formed so as to be symmetrical with the loading unit, and includes a transferring belt rotated via several rollers by a motor formed on one end of the engine-waiting track, and a guider with a cavity separated from the belt by a predetermined distance so as to be opposite to the belt.

3. The apparatus for cleaning bottles as set forth in claim 2,
wherein overturning guide spaces with a curvature portion formed along the trajectory of the bottles generated by a 180° turn are respectively formed within the front and rear overturning sections, and
wherein a transferring guide space with a curvature portion formed along the trajectory of the bottles generated by a straight-line movement is formed within the cleaning section, and a through hole for allowing air sprayed from spraying nozzles of the cleaning means to be directly injected into the inside of the bottles is longitudinally formed on the lower surface of the guide space.

4. The apparatus for cleaning bottles as set forth in claim 1,
wherein said air supplying unit is formed so that the supplied external air in the ionized state passing through the filter to the compressor is neutralized by the ionizer and then supplied to a plurality of the spraying nozzles by a compression air supply pipe,
wherein said air cleaning unit is formed so that the compression air supply pipe and a distributor are connected to each other within a hermetic duct installed under the engine-waiting track, a plurality of the spraying nozzles spaced from each other by a designated distance are installed between the distributor and the through hole so as to be connected to the inside of the distributor, and a discharge slot is formed on one end of the duct, and
wherein said air exhausting unit is formed so that the discharge slot and the collector are connected to each other by a connection pipe so that the impurities eliminated from the bottles by the air cleaning are collected into the collector by the suction pump such as a ring blower and the exhausted air is discharged to the outside via the filter, and the collector and the suction pump are connected to each other and the suction pump and the filter are connected to each other.

5. The apparatus for cleaning bottles as set forth in claim 4,
wherein a plurality of bactericidal lamps are respectively installed between the spraying nozzles on the distributor, thereby radiating a bactericidal light to the insides of the bottles via the through hole so as to disinfect the insides of the bottles.
